(19) United States
(12) Patent Application Publication
(10) Pub. No.: US 2026/0292151 A1
(43) Pub. Date: Sep. 24, 2026

(54) ELECTRONIC DEVICE AND NON-TRANSITORY MACHINE-READABLE MEDIUM FOR DECODING AND/OR ENCODING VIDEO DATA

(71) Applicant: SHARP KABUSHIKI KAISHA, Sakai City (JP)

(72) Inventor: YI-HAO LIN, New Taipei City (TW)

(21) Appl. No.: 19/571,378

(22) Filed: Mar. 18, 2026

Related U.S. Application Data
(60) Provisional application No. 63/773,662, filed on Mar. 18, 2025.

(51) Int. Cl. H04N 19/11; H04N 19/105; H04N 19/176

(52) U.S. Cl. CPC H04N 19/11; H04N 19/105; H04N 19/176

(57) ABSTRACT

A method of decoding/encoding video data is provided. The method determines a block unit of an image frame, included in the video data; selects, using a neighboring region neighboring the block unit, one or more intra default modes from intra default candidates for predicting the block unit in a template-based intra mode derivation mode; determines one or more first block prediction candidates for the block unit using, respectively, the one or more intra default modes; selects an intra non-angular mode from intra non-angular candidates including a neural network-based intra prediction mode; determines, using the intra non-angular mode, a second block prediction candidate; determines a block prediction for the block unit by weighted blending the first and second block prediction candidates; and reconstructs the block unit based on the block prediction. An electronic device and a non-transitory machine-readable medium of an electronic device implementing the provided method are also provided.

### CROSS-REFERENCE TO RELATED APPLICATION(S)

The present disclosure claims the benefit of and priority to U.S. Provisional Patent Application Ser. No. 63/773,662, filed on Mar. 18, 2025, entitled “TIMD FUSION WITH NEURAL NETWORK BASED INTRA PREDICTION,” the content of which is hereby incorporated herein fully by reference in its entirety for all purposes.

### FIELD

The present disclosure generally relates to video coding, and more specifically, to techniques for predicting and/or reconstructing a block unit based on a template-based intra mode derivation (TIMD) candidate list of a TIMD fusion mode, the TIMD candidate list including a neural network-based intra prediction mode.

### BACKGROUND

Template-based intra mode derivation (TIMD) mode and TIMD fusion mode are coding tools for video coding, in each of which, an encoder and/or a decoder may predict a block unit of a current block based on a neighboring region of the block unit.

In addition, the encoder and/or the decoder may predict the neighboring region by using multiple intra default candidates to generate multiple predicted results of the neighboring region. In the TIMD mode, the encoder and/or the decoder may further compare the predicted results with a previously reconstructed result of the neighboring region for selecting one or more intra default modes from the intra default candidates.

In the TIMD fusion mode, the encoder and/or the decoder may predict the block unit by using the selected intra default modes in the TIMD mode to generate one or more predicted results of the block unit. The encoder and/or the decoder may then fuse the one or more predicted results and a non-angular predicted result with multiple weights to generate a final predicted result of the block unit.

The number of intra default candidates for selecting the intra default modes in the TIMD mode is much greater than the number of non-angular candidates for generating the non-angular predicted result. Thus, each of the non-angular candidates may not be the most appropriate mode, such that the non-angular candidates may be inadequate to precisely and efficiently predict the block unit.

Therefore, a new non-angular candidate for precisely and efficiently predicting the block unit in the TIMD fusion mode may be required for the encoder and/or the decoder to be able to precisely and efficiently predict and/or reconstruct the block unit of the current block. In addition, other supporting schemes for the new non-angular candidate may also be required for the encoder and/or the decoder to properly implement the new non-angular candidate in the TIMD fusion mode.

### SUMMARY

The present disclosure is directed to a non-transitory machine-readable medium and an electronic device for predicting and/or reconstructing a block unit based on a template-based intra mode derivation (TIMD) candidate list of a TIMD fusion mode, the TIMD candidate list including a neural network-based intra prediction mode.

In a first aspect of the present disclosure, an electronic device for decoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a block unit of an image frame that is included in the video data; select, using a neighboring region, one or more intra default modes from multiple intra default candidates for predicting the block unit in a template-based intra mode derivation (TIMD) mode, the neighboring region neighboring the block unit; determine one or more first block prediction candidates for the block unit using the one or more intra default modes, each of the one or more first block prediction candidates corresponding to one of the one or more intra default modes; select an intra non-angular mode from multiple intra non-angular candidates that includes a neural network-based intra prediction mode; determine, using the intra non-angular mode, a second block prediction candidate for the block unit; determine a block prediction for the block unit by weighted blending the one or more first block prediction candidates and the second block prediction candidate; and reconstruct the block unit based on the block prediction.

In an implementation of the first aspect of the present disclosure, selecting the intra non-angular mode from the multiple intra non-angular candidates includes: directly setting the neural network-based intra prediction mode as the intra non-angular mode.

In an implementation of the first aspect of the present disclosure, selecting the intra non-angular mode from the multiple intra non-angular candidates includes: determining multiple regional non-angular predictions for the neighboring region using the multiple intra non-angular candidates, each of the multiple regional non-angular predictions corresponding to one of the multiple intra non-angular candidates; determining a regional reconstruction of the neighboring region, the regional reconstruction being generated prior to the selection of the one or more intra default modes; comparing each of the multiple regional non-angular predictions with the regional reconstruction to generate multiple non-angular template costs, each of the multiple non-angular template costs corresponding to one of the multiple intra non-angular candidates; and selecting, using the multiple non-angular template costs, the intra non-angular mode from the multiple intra non-angular candidates.

In an implementation of the first aspect of the present disclosure, the one or more computer-executable instructions, when executed by the at least one processor of the electronic device, further cause the electronic device to: derive, according to multiple angular default candidates, a transformed intra mode corresponding to the neural network-based intra prediction mode of the block unit, the multiple angular default candidates being included in the multiple intra default candidates, wherein the regional non-angular prediction of the neural network-based intra prediction mode is determined using the transformed intra mode.

In an implementation of the first aspect of the present disclosure, a neural network-based template cost that corresponds to the neural network-based intra prediction mode is included in the multiple non-angular template costs, multiple default template costs is generated, according to the neighboring region, by using the multiple intra default candidates in the TIMD mode, each of the multiple default template costs corresponds to one of the multiple intra default candidates, and the neural network-based intra prediction mode is allowed to be selected as the intra non-angular mode when the neural network-based template cost is less than a specific cost value calculated by multiplying a minimum template cost of the multiple default template costs by a predefined value.

In an implementation of the first aspect of the present disclosure, the one or more computer-executable instructions, when executed by the at least one processor of the electronic device, further cause the electronic device to, in a case that the neural network-based intra prediction mode is selected as the intra non-angular mode: determine a specific template cost from multiple remaining non-angular template costs generated by excluding a neural network-based template cost from the multiple non-angular template costs, wherein the neural network-based template cost is determined by using the neural network-based intra prediction mode, and determine, using the specific template cost, a weighting parameter for the neural network-based intra prediction mode.

In an implementation of the first aspect of the present disclosure, the one or more computer-executable instructions, when executed by the at least one processor of the electronic device, further cause the electronic device to, in a case that the neural network-based intra prediction mode is selected as the intra non-angular mode: derive, according to multiple angular default candidates, a transformed intra mode corresponding to the neural network-based intra prediction mode of the block unit, the multiple angular default candidates being included in the multiple intra default candidates, determine, using the transformed intra mode, a regional neural network-based prediction for the neighboring region, determine a regional reconstruction of the neighboring region, the regional reconstruction being generated prior to the selection of the one or more intra default modes, compare the regional neural network-based prediction with the regional reconstruction to generate the neural network-based template cost, and determine, using the neural network-based template cost, a weighting parameter for the neural network-based intra prediction mode.

In a second aspect of the present disclosure, an electronic device for encoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a block unit of an image frame that is included in the video data; select, using a neighboring region, one or more intra default modes from multiple intra default candidates for predicting the block unit in a template-based intra mode derivation (TIMD) mode, the neighboring region neighboring the block unit; determine one or more first block prediction candidates for the block unit using the one or more intra default modes, each of the one or more first block prediction candidates corresponding to one of the one or more intra default modes; select an intra non-angular mode from multiple intra non-angular candidates that includes a neural network-based intra prediction mode; determine, using the intra non-angular mode, a second block prediction candidate for the block unit; determine a block prediction for the block unit by weighted blending the one or more first block prediction candidates and the second block prediction candidate; and reconstruct the block unit based on the block prediction.

In an implementation of the second aspect of the present disclosure, selecting the intra non-angular mode from the multiple intra non-angular candidates includes: directly setting the neural network-based intra prediction mode as the intra non-angular mode.

In an implementation of the second aspect of the present disclosure, selecting the intra non-angular mode from the multiple intra non-angular candidates includes: determining multiple regional non-angular predictions for the neighboring region using the multiple intra non-angular candidates, each of the multiple regional non-angular predictions corresponding to one of the multiple intra non-angular candidates; determining a regional reconstruction of the neighboring region, the regional reconstruction being generated prior to the selection of the one or more intra default modes; comparing each of the multiple regional non-angular predictions with the regional reconstruction to generate multiple non-angular template costs, each of the multiple non-angular template costs corresponding to one of the multiple intra non-angular candidates; and selecting, using the multiple non-angular template costs, the intra non-angular mode from the multiple intra non-angular candidates.

In an implementation of the second aspect of the present disclosure, the one or more computer-executable instructions, when executed by the at least one processor of the electronic device, further cause the electronic device to: derive, according to multiple angular default candidates, a transformed intra mode corresponding to the neural network-based intra prediction mode of the block unit, the multiple angular default candidates being included in the multiple intra default candidates, wherein the regional non-angular prediction of the neural network-based intra prediction mode is determined using the transformed intra mode.

In an implementation of the second aspect of the present disclosure, a neural network-based template cost that corresponds to the neural network-based intra prediction mode is included in the multiple non-angular template costs, multiple default template costs is generated, according to the neighboring region, by using the multiple intra default candidates in the TIMD mode, each of the multiple default template costs corresponds to one of the multiple intra default candidates, and the neural network-based intra prediction mode is allowed to be selected as the intra non-angular mode when the neural network-based template cost is less than a specific cost value calculated by multiplying a minimum template cost of the multiple default template costs by a predefined value.

In an implementation of the second aspect of the present disclosure, the one or more computer-executable instructions, when executed by the at least one processor of the electronic device, further cause the electronic device to, in a case that the neural network-based intra prediction mode is selected as the intra non-angular mode: determine a specific template cost from multiple remaining non-angular template costs generated by excluding a neural network-based template cost from the multiple non-angular template costs, wherein the neural network-based template cost is determined by using the neural network-based intra prediction mode, and determine, using the specific template cost, a weighting parameter for the neural network-based intra prediction mode.

In an implementation of the second aspect of the present disclosure, the one or more computer-executable instructions, when executed by the at least one processor of the electronic device, further cause the electronic device to, in a case that the neural network-based intra prediction mode is selected as the intra non-angular mode: derive, according to multiple angular default candidates, a transformed intra mode corresponding to the neural network-based intra prediction mode of the block unit, the multiple angular default candidates being included in the multiple intra default candidates, determine, using the transformed intra mode, a regional neural network-based prediction for the neighboring region, determine a regional reconstruction of the neighboring region, the regional reconstruction being generated prior to the selection of the one or more intra default modes, compare the regional neural network-based prediction with the regional reconstruction to generate the neural network-based template cost, and determine, using the neural network-based template cost, a weighting parameter for the neural network-based intra prediction mode.

In a third aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a block unit of an image frame that is included in the video data; select, using a neighboring region, one or more intra default modes from multiple intra default candidates for predicting the block unit in a template-based intra mode derivation (TIMD) mode, the neighboring region neighboring the block unit; determine one or more first block prediction candidates for the block unit using the one or more intra default modes, each of the one or more first block prediction candidates corresponding to one of the one or more intra default modes; select an intra non-angular mode from multiple intra non-angular candidates that includes a neural network-based intra prediction mode; determine, using the intra non-angular mode, a second block prediction candidate for the block unit; determine a block prediction for the block unit by weighted blending the one or more first block prediction candidates and the second block prediction candidate; and reconstruct the block unit based on the block prediction.

In an implementation of the third aspect of the present disclosure, selecting the intra non-angular mode from the multiple intra non-angular candidates includes: directly setting the neural network-based intra prediction mode as the intra non-angular mode.

In an implementation of the third aspect of the present disclosure, selecting the intra non-angular mode from the multiple intra non-angular candidates includes: determining multiple regional non-angular predictions for the neighboring region using the multiple intra non-angular candidates, each of the multiple regional non-angular predictions corresponding to one of the multiple intra non-angular candidates; determining a regional reconstruction of the neighboring region, the regional reconstruction being generated prior to the selection of the one or more intra default modes; comparing each of the multiple regional non-angular predictions with the regional reconstruction to generate multiple non-angular template costs, each of the multiple non-angular template costs corresponding to one of the multiple intra non-angular candidates; and selecting, using the multiple non-angular template costs, the intra non-angular mode from the multiple intra non-angular candidates.

In an implementation of the third aspect of the present disclosure, the one or more computer-executable instructions, when executed by the at least one processor of the electronic device, further cause the electronic device to: derive, according to multiple angular default candidates, a transformed intra mode corresponding to the neural network-based intra prediction mode of the block unit, the multiple angular default candidates being included in the multiple intra default candidates, wherein the regional non-angular prediction of the neural network-based intra prediction mode is determined using the transformed intra mode.

In an implementation of the third aspect of the present disclosure, a neural network-based template cost that corresponds to the neural network-based intra prediction mode is included in the multiple non-angular template costs, multiple default template costs is generated, according to the neighboring region, by using the multiple intra default candidates in the TIMD mode, each of the multiple default template costs corresponds to one of the multiple intra default candidates, and the neural network-based intra prediction mode is allowed to be selected as the intra non-angular mode when the neural network-based template cost is less than a specific cost value calculated by multiplying a minimum template cost of the multiple default template costs by a predefined value.

In an implementation of the third aspect of the present disclosure, the one or more computer-executable instructions, when executed by the at least one processor of the electronic device, further cause the electronic device to, in a case that the neural network-based intra prediction mode is selected as the intra non-angular mode: determine a specific template cost from multiple remaining non-angular template costs generated by excluding a neural network-based template cost from the multiple non-angular template costs, wherein the neural network-based template cost is determined by using the neural network-based intra prediction mode, and determine, using the specific template cost, a weighting parameter for the neural network-based intra prediction mode.

In an implementation of the third aspect of the present disclosure, the one or more computer-executable instructions, when executed by the at least one processor of the electronic device, further cause the electronic device to, in a case that the neural network-based intra prediction mode is selected as the intra non-angular mode: derive, according to multiple angular default candidates, a transformed intra mode corresponding to the neural network-based intra prediction mode of the block unit, the multiple angular default candidates being included in the multiple intra default candidates, determine, using the transformed intra mode, a regional neural network-based prediction for the neighboring region, determine a regional reconstruction of the neighboring region, the regional reconstruction being generated prior to the selection of the one or more intra default modes, compare the regional neural network-based prediction with the regional reconstruction to generate the neural network-based template cost, and determine, using the neural network-based template cost, a weighting parameter for the neural network-based intra prediction mode.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIG. 4 is a schematic diagram illustrating a neighboring region and a reference region of a block unit, in accordance with one or more example implementations of this disclosure.

FIG. 5 is a schematic diagram illustrating a neural network-based region of a block unit, in accordance with one or more example implementations of this disclosure.

FIGS. 6A-6C are schematic diagrams illustrating different calculation functions to predict the block unit, having different sizes, in the neural network-based intra prediction mode, in accordance with one or more example implementations of this disclosure.

FIG. 7 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on at least one computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium or a non-transitory machine-readable medium.

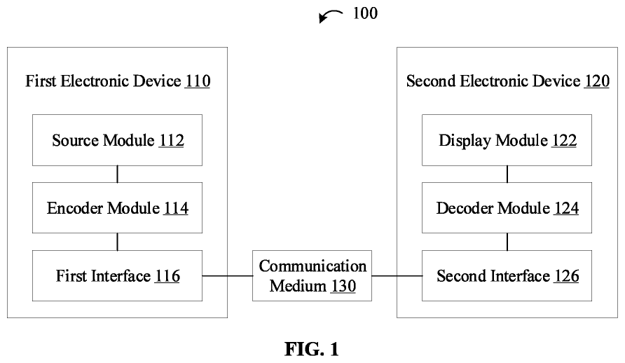

FIG. 1 is a block diagram illustrating a system 100 having a first electronic device and a second electronic device for encoding and decoding video data, in accordance with one or more example implementations of this disclosure.

The system 100 may include a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and/or the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

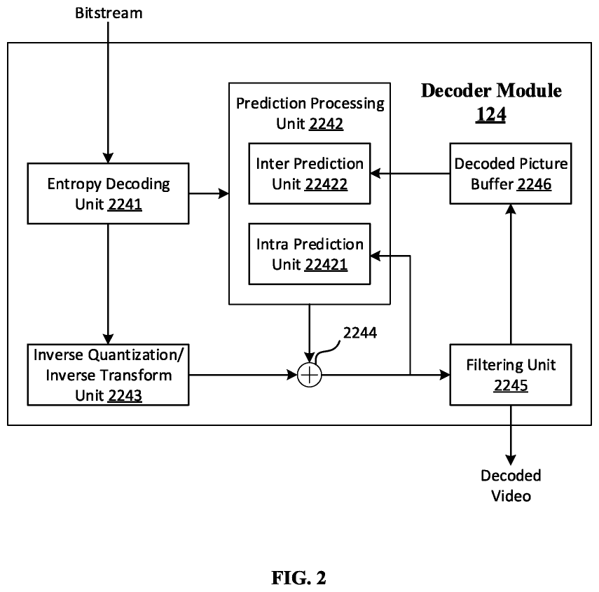

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames based on the partition information.

Each of the image frames may be divided into at least one image block based on the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame, as the current block unit, based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components are reconstructed by using the prediction processing unit 2242.

The intra prediction unit 22421 may reconstruct multiple chroma components of the current block unit based on the multiple luma components of the current block unit when the multiple luma components of the current block unit are reconstructed by using the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (are not explicitly illustrated for brevity of the description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

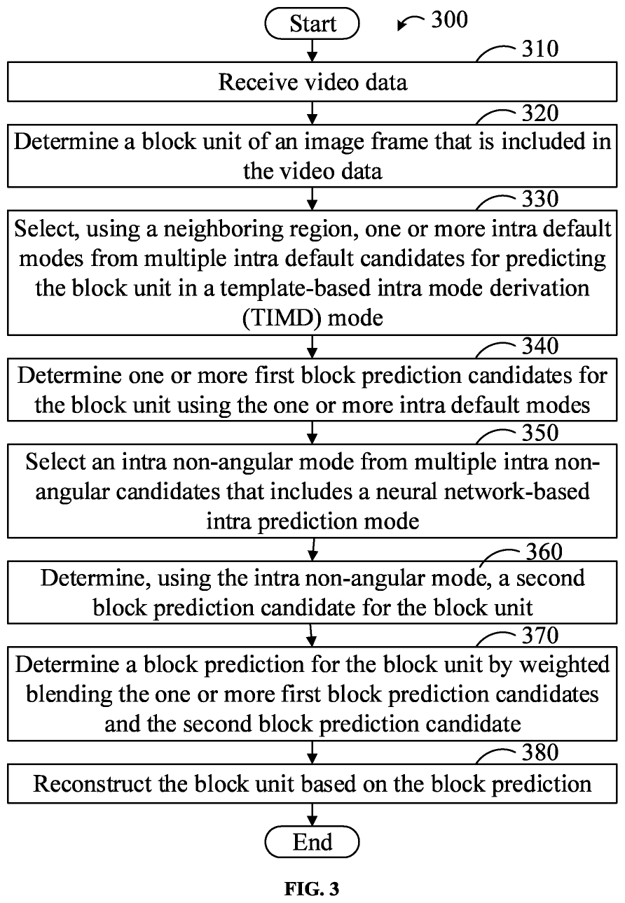

FIG. 3 is a flowchart illustrating a method/process 300 for decoding and/or encoding video data by an electronic device, in accordance with one or more example implementations of this disclosure. The method/process 300 is an example implementation, as there may be a variety of mechanisms of decoding the video data.

The method/process 300 may be performed by an electronic device using the configurations illustrated in FIGS. 1 and/or 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus the order may be different from what is illustrated. Additional blocks may be added or fewer blocks may be utilized without departing from the scope of the present disclosure.

With reference to FIG. 3, at block 310, the method/process 300 may start by receiving (e.g., via the decoder module 124, as shown in FIG. 2) the video data. The video data, received by the decoder module 124, may include a bitstream.

With reference to FIGS. 1 and 2, the second electronic device 120 may receive the bitstream from an encoder, such as the first electronic device 110 (or other video providers), via the second interface 126.

At block 320, the decoder module 124 may determine a block unit of an image frame included in the video data.

With reference to FIGS. 1 and 2, the decoder module 124 may determine the image frames, included in the bitstream, when the video data, received by the decoder module 124, includes the bitstream. The current frame may be one of the image frames, determined based on the bitstream. The decoder module 124 may further divide the current frame to determine the block unit, according to the partition indications in the bitstream. In some implementations, the decoder module 124 may divide the current frame to generate multiple CTUs, and may further divide a current CTU, included in the CTUs, to generate multiple divided blocks. The decoder module 124 may determine the block unit from the divided blocks, according to the partition indications (e.g., based on any video coding standard). In some implementations, the block unit may be one of a luma block unit and a chroma block unit.

In some other implementations, the decoder module 124 may divide the current frame to generate multiple slices or multiple tiles, and may further divide a current slice or a current tile, included in the slices or the tiles, to generate multiple CTUs. In addition, the decoder module 124 may further divide a current CTU, included in the CTUs, to generate multiple divided blocks and to determine the block unit from the divided blocks, based on the partition indications.

The block size Wb×Hb of the block unit may be determined based on a block width Wb and a block height Hb. In some implementations, the block width Wb and the block height Hb may be positive integers that are, respectively, equal to, or greater than, two. In addition, a block location of the block unit may be represented by (xCb, yCb) specifying a top-left luma sample of the block unit relative to a top-left luma sample of the current frame.

Referring back to FIG. 3, at block 330, the decoder module 124 may select, using a neighboring region, one or more intra default modes from multiple intra default candidates for predicting the block unit in a template-based intra mode derivation (TIMD) mode. The neighboring region may neighbor the block unit.

With reference to FIG. 1 and FIG. 2, the decoder module 124 may determine a neighboring region that neighbors the block unit. The neighboring region may include multiple template blocks that neighbor the block unit. In addition, the decoder module 124 may determine a reference region that neighbors the neighboring region.

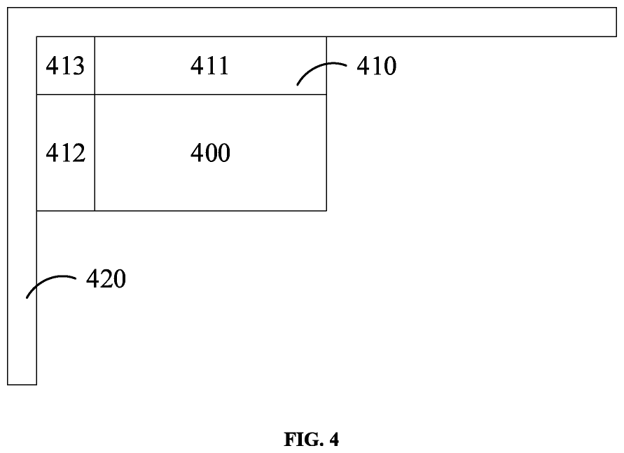

FIG. 4 is a schematic diagram illustrating a neighboring region 410 and a reference region 420 of a block unit 400, in accordance with one or more example implementations of this disclosure. The neighboring region 410 may include one or more template blocks 411-413 that neighbor the block unit 400. In addition, the reference region 420 that neighbors the one or more template blocks 411-413 of the neighboring region 410 may be determined according to the one or more template blocks of the neighboring region 410.

A first template block 411 may be a left neighboring block located at the left side of the block unit 400, a second template block 412 may be a top neighboring block located above the block unit 400, and a third template block 413 may be a top-left neighboring block located at the top-left side of the block unit 400. A height of the top neighboring block may be equal to the number Nbt of template reconstructed samples of the top neighboring block along a vertical direction, and a width of the top neighboring block may be equal to a width of the block unit 400.

A height of the left neighboring block may be equal to a height of the block unit 400, and a width of the left neighboring block may be equal to the number Nbl of template reconstructed samples of the left neighboring block along a horizontal direction. In addition, a height of the top-left neighboring block may be equal to the number Nbt of template reconstructed samples of the top neighboring block along the vertical direction, and a width of the top-left neighboring block may be equal to the number Nbl of template reconstructed samples of the left neighboring block along the horizontal direction. In some implementations, the parameters Nbt and Nbl may be positive integers. In addition, Nbt and Nbl may be to the same, or may be different from each other. Furthermore, Nbt and Nbl may be greater than, or equal to, one. For example, Nbt may be equal to one, two, three, or four, and Nbt may be equal to one, two, three, or four.

In some implementations, the neighboring region 410 may include the template reconstructed samples of the top neighboring block, the left neighboring block, and the top-left neighboring block. Thus, the template reconstructed samples of the top neighboring block, the left neighboring block, and the top-left neighboring block may be represented as a regional reconstruction of the neighboring region 410. In addition, the regional reconstruction of the neighboring region 410 may be reconstructed prior to the reconstruction of the block unit 400. In some implementations, the regional reconstruction of the neighboring region 410 may be reconstructed prior to the selection of the one or more intra default modes.

In some implementations, the reference region 420 may include multiple template reference samples reconstructed prior to the reconstruction of the block unit 400. In some implementations, the template reference samples of the reference region 420 may be reconstructed prior to the selection of the one or more intra default modes.

The block unit 400 has a block width Wb and a block height Hb. The first template block 411 may have a first template width Wt1 and a first template height Ht1, the second template block 412 may have a second template width Wt2 and a second template height Ht2, and the third template block 5103 may have a third template width Wt3 and a third template height Ht3. In some implementations, the first template height Ht1 may be equal to the block height Hb, and the second template width Wt2 may be equal to the block width Wb. In addition, the first template width Wt1 and the third template width Wt3 may be equal to a template width Wt of the neighboring region 410, and the second template height Ht2 and third template height Ht3 may be equal to a template height Ht of the neighboring region 410.

The reference region 420 may have a reference width Wr and a reference height Hr. Furthermore, the reference width Wr may be equal to 2× (Wb+Wt)+1, and the reference height Hr may be equal to 2× (Hb+Ht)+1. In some implementations, the parameters Wt1, Ht1, Wt2, Ht2, Wt3, Ht3, Wt, Ht, Wr, and Hr may be positive integers. In some implementations, Wt and Ht may be the same. In some other implementations, Wt and Ht may be different.

The decoder module 124 may predict the neighboring region based on the reference region by using multiple intra default candidates for predicting the block unit in a template-based intra mode derivation (TIMD) mode. In some implementations, the intra default candidates may be determined from multiple non-angular default modes and multiple angular default modes. The non-angular default modes may include a Planar mode and a DC mode. In addition, the number of angular default modes may be equal to 32, e.g., when the decoder module 124 decodes the block unit in high efficiency video coding (HEVC). The number of angular default modes may be equal to 65, e.g., when the decoder module 124 decodes the block unit in versatile video coding (VVC) or VVC test model (VTM). Furthermore, the number of angular default modes may be equal to 129, e.g., when the decoder module 124 decodes the block unit in enhanced compression model (ECM). Thus, the number of intra default candidates may be equal to, or less than, 34 in HEVC, equal to, or less than, 67 in VVC or VTM, and equal to, or less than, 131 in ECM.

In some implementations, the intra default candidates may be determined from the angular default modes. Thus, the number of intra default candidates may be equal to, or less than, 32 in HEVC, equal to, or less than, 65 in VVC or VTM, and equal to, or less than, 129 in ECM.

In some implementations, the decoder module 124 may select multiple most probable modes (MPMs) from the angular default modes and the non-angular default modes based on one or more intra neighboring modes of multiple neighboring units. The neighboring units may neighbor the block unit 400. In addition, each of the neighboring units may be reconstructed using a corresponding one of the intra neighboring modes prior to the reconstruction of the block unit 400. In some implementations, the number of MPMs may be equal to 6. In some implementations, the MPMs may include multiple primary MPMs and multiple secondary MPMs in ECM. In some implementations, the number of primary MPMs may be equal to 6, and the number of secondary MPMs may be equal to 16. Thus, the total number of MPMs may be equal to 22.

In some implementations, the decoder module 124 may predict, by using each of the intra default candidates, the neighboring region to generate multiple regional default predictions. Thus, each of the regional default predictions may correspond to one of the angular default modes. In some other implementations, the decoder module 124 may predict the neighboring region to generate the regional default predictions by using each of the intra default candidates that are selected from the angular default modes. Thus, each of the regional default predictions may correspond to one of the angular default modes. In some other implementations, the decoder module 124 may predict the neighboring region to generate the regional default predictions only by using each of the MPMs that are selected from the angular default modes and the non-angular default modes. Thus, each of the regional default predictions may correspond to one of the MPMs.

In some implementations, the decoder module 124 may compare each of the regional default predictions with the regional reconstruction to generate multiple default template costs. Thus, each of the default template costs may correspond to one of the regional default predictions. In addition, in the TIMD mode, the default template costs may be generated, according to the neighboring region, by using the intra default candidates, and each of the default template costs may correspond to one of the intra default candidates. In some other implementations, when the regional default predictions are generated by using each of the intra default candidates that are only selected from the angular default modes, each of the default template costs may correspond to one of the angular default modes. In some other implementations, when the regional default predictions are generated only by using the MPMs, each of the default template costs may correspond to one of the MPMs.

In some implementations, in the TIMD mode, the decoder module 124 may select the one or more intra default modes from the intra default candidates by using the default template costs. When the default template costs are generated by using the intra default candidates that are only selected from the angular default modes, the decoder module 124 may select, in the TIMD mode, the one or more intra default modes from the angular default modes. In addition, when the default template costs are generated by using the MPMs of the block unit, the decoder module 124 may select, in the TIMD mode, the one or more intra default modes from the MPMs.

In some implementations, the parameter Nd of intra default modes, selected from the intra default candidates, may be a positive integer being greater than zero. For example, Nd may be equal to one, two, three, four, or five. In some other implementations, the number of intra default modes, only selected from the angular default modes, may be an integer being greater than, or equal to, zero. For example, the number of intra default modes, only selected from the angular default modes, may be equal to zero, one, two, three, four, or five. In some other implementations, the number of intra default modes, selected from the MPMs, may be an integer being greater than, or equal to, zero. In some implementations, the selected intra default modes may correspond to the intra default candidates having the Nd-th lowest default template costs.

In some implementations, the template costs, including the default template costs, may be derived based on the neighboring regions by using a cost function. The cost function may be one of a Sum of Absolute Difference (SAD) process, a Mean-removal SAD (MR-SAD) process, a Weighted SAD process, a Sum of Absolute Transformed Difference (SATD) process, a Mean Absolute Difference (MAD) process, a Mean Squared Difference (MSD) process, and a Structural SIMilarity (SSIM) process. It should be noted that any cost function may be applied without departing from this disclosure.

Referring back to FIG. 3, at block 340, the decoder module 124 may determine one or more first block prediction candidates for the block unit using one or more intra default modes. Each of the one or more first block prediction candidates may correspond to one of the one or more intra default modes.

With reference to FIG. 1 and FIG. 2, the decoder module 124 may predict the block unit by using each of the one or more intra default modes based on one or more reference lines. The one or more reference lines may neighbor the block unit. In addition, the one or more reference lines may include multiple reconstructed line samples reconstructed prior to the reconstruction of the block unit. In some implementations, the reconstructed line samples of the one or more reference lines may be reconstructed prior to the selection of the one or more intra default modes.

In some implementations, the decoder module 124 may determine the one or more first block prediction candidates for the block unit using the one or more intra default modes. Each of the one or more first block prediction candidates may be determined by predicting the block unit using a corresponding one of the one or more intra default modes based on the one or more reference lines. Thus, each of the one or more first block prediction candidates may correspond to one of the one or more intra default modes.

Referring back to FIG. 3, at block 350, the decoder module 124 may select an intra non-angular mode from multiple intra non-angular candidates that includes a neural network-based intra prediction mode.

With reference to FIG. 1 and FIG. 2, the decoder module 124 may predict the neighboring region based on the reference region by using the intra non-angular candidates. The intra non-angular candidates may include the neural network-based intra prediction mode. In addition, the intra non-angular candidates may further include the non-angular default modes that include the DC mode and the Planar mode. In some implementations, the intra non-angular candidates may further include at least one of a block-vector-based prediction mode, a matrix-weighted intra prediction (MIP), or a position dependent prediction (PDP) mode.

In some implementations, the decoder module 124 may directly set the neural network-based intra prediction mode as the intra non-angular mode. In other words, the neural network-based intra prediction mode may be predefined as the intra non-angular mode without any selection procedure.

In some implementations, in order to select the intra non-angular mode, the decoder module 124 may determine multiple regional non-angular predictions for the neighboring region using the intra non-angular candidates. The regional non-angular predictions may be generated by predicting the neighboring region using the intra non-angular candidates. Thus, each of the regional non-angular predictions may correspond to one of the intra non-angular candidates.

In some implementations, the decoder module 124 may compare each of the regional non-angular predictions with the regional reconstruction of the neighboring region to generate multiple non-angular template costs. In some implementations, the regional reconstruction may be reconstructed prior to the reconstruction of the block unit. In some implementations, the regional reconstruction of the neighboring region may be reconstructed prior to the selection of the one or more intra default modes. In some implementations, each of the non-angular template costs may correspond to one of the regional non-angular predictions.

In some implementations, the template costs, including the non-angular template costs, may be derived based on the neighboring regions by using a cost function. The cost function may be at least one of an SAD process, an MR-SAD process, a Weighted SAD process, an SATD process, an MAD process, an MSD process, and an SSIM process. It should be noted that any cost function may be used without departing from this disclosure.

In some implementations, the decoder module 124 may select the intra non-angular mode from the intra non-angular candidates based on the non-angular template costs. For example, the decoder module 124 may select a specific intra non-angular candidate from the intra non-angular candidates as the intra-non-angular mode. The specific intra non-angular candidate may correspond to a minimum cost value of the non-angular template costs.

In some implementations, before the decoder module 124 predicts the neighboring region based on the reference region in the neural network-based intra prediction mode, the decoder module 124 may predict, in advance, the block unit in the neural network-based intra prediction mode based on a neural network-based region, neighboring the block unit. The neural network-based region may include multiple neural network-based reference samples reconstructed prior to the reconstruction of the block unit. In some implementations, the neural network-based reference samples may be reconstructed prior to the selection of the one or more intra default modes.

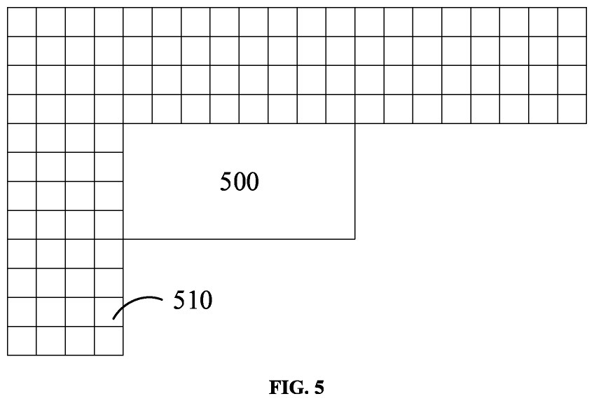

FIG. 5 is a schematic diagram illustrating a neural network-based region 510 of a block unit 500, in accordance with one or more example implementations of this disclosure. The neural network-based region 510 may neighbor the block unit 500 and include multiple neural network-based reference samples.

In some implementations, the neural network-based region 510 may include a left portion located at the left side of the block unit 500 and a top portion located above the block unit 500. A width of the left portion may be equal to the number Nnl of neural network-based reference samples in the left portion along the horizontal direction, and a height of the top portion may be equal to the number Nnt of neural network-based reference samples in the top portion along the vertical direction. In some implementations, the parameter Nnt may be a positive integer being greater than, or equal to, two. For example, Nnt may be equal to two, four, six, or eight. In some implementations, the parameter Nnl may be a positive integer being greater than, or equal to, two. For example, Nnl may be equal to two, four, six, or eight. In some implementations, Nnt and Nnl may be the same.

In some implementations, when the block height Hb is greater than, or equal to, eight, and the block weight Wb is also greater than, or equal to, eight, both Nnt and Nnl may be equal to eight. In some implementations, when the block height Hb is less than eight, both Nnt and Nnl may be equal to four. In some implementations, when the block width Wb is less than eight, both Nnt and Nnl may be equal to four. In FIG. 5, when the block height Hb is equal to four, and the block width Wb is equal to eight, both Nnt and Nnl may be equal to four.

In some implementations, a height of the left portion may be equal to Nnt+2Hb+Enl, and a width of the top portion may be equal to Nnl+2Hb+Ent. In some implementations, Enl may be a left extension number, and Ent may be a top extension number. In some implementations, Enl may be an integer being equal to, or greater than, zero. For example, Enl may be equal to zero, two, four, six, or eight. In some implementations, Ent may be an integer being equal to, or greater than, zero. For example, Ent may be equal to zero, two, four, six, or eight. In some implementations, Enl may be equal to Ent. In FIG. 5, both Enl and Ent may be equal to zero.

In some implementations, the neural network-based reference samples in the neural network-based region 510 may be pre-processed by calculating a mean of the neural network-based reference samples and subtracting the mean from each of the neural network-based reference samples to generate the neural network-based pre-processed samples.

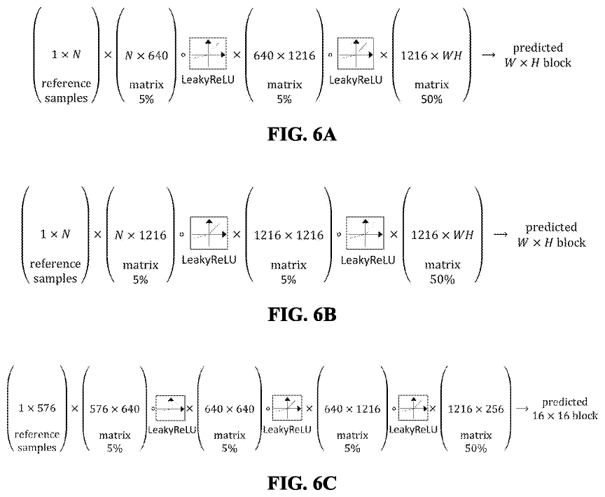

In some implementations, the decoder module 124 may use multiple calculation functions to predict the block unit when the neural network-based intra prediction mode is used. In some implementations, the calculation functions may include at least one of multiple sequential matrix multiplications and a piecewise-linear function in the neural network-based intra prediction mode. In some implementations, the piecewise-linear function may include a Leaky Rectified Linear Units (LeakyReLU). FIGS. 6A-6C are schematic diagrams illustrating different calculation functions to predict the block unit, having different sizes, in the neural network-based intra prediction mode, in accordance with one or more example implementations of this disclosure. In some implementations, the calculation functions in the neural network-based intra prediction mode may be predefined in the second electronic device 120 and the first electronic device 110. Thus, the calculation functions that are used in the neural network-based intra prediction mode by the decoder module 124 may be identical to those that are used in the neural network-based intra prediction mode by the encoder module 114. In some implementations, the neural network-based intra prediction mode may be performed by using the neural network-based intra prediction mode in ECM. It should be noted that any calculation functions in the neural network-based intra prediction mode may be used without departing from this disclosure.

In some implementations, the neural network-based pre-processed samples may be input into the calculation functions in the neural network-based intra prediction mode to generate a neural network-based block prediction of the block unit 510. In some other implementations, the neural network-based reference samples may be directly input into the calculation functions in the neural network-based intra prediction mode to generate the neural network-based block prediction of the block unit 510.

In some implementations, in order to predict the neighboring region in the neural network-based intra prediction mode, the decoder module 124 may derive, according to multiple angular default candidates, a transformed intra mode corresponding to the neural network-based intra prediction mode of the block unit. The angular default candidates may be included in the intra default candidates. In some implementations, the angular default candidates may be the angular default modes in HEVC, VVC, VTM, or ECM. In some other implementations, the angular default candidates may be pre-selected from the angular default modes in HEVC, VVC, VTM, or ECM. The regional non-angular prediction of the neural network-based intra prediction mode may be determined using the transformed intra mode.

In some implementations, the transformed intra mode that corresponds to the neural network-based intra prediction mode may be derived by a decoder side intra mode derivation (DIMD) mode based on the neural network-based block prediction of the block unit 510. In some implementations, the transformed intra mode that corresponds to the neural network-based intra prediction mode may be derived by a template matching prediction (TMP) mode based on the neural network-based block prediction of the block unit 510. In some implementations, the transformed intra mode that corresponds to the neural network-based intra prediction mode may be derived by an extrapolation intra prediction (EIP) mode based on the neural network-based block prediction of the block unit 510. In some implementations, the transformed intra mode that corresponds to the neural network-based intra prediction mode may be derived by the MIP mode based on the neural network-based block prediction of the block unit 510.

In some implementations, when the decoder module 124 predicts the neighboring region based on the reference region in the neural network-based intra prediction mode, the decoder module 124 predicts the neighboring region based on the reference region by using the transformed intra mode. Thus, a specific one of the regional non-angular predictions may be generated by using the transformed intra mode. The specific regional non-angular prediction may correspond to the neural network-based intra prediction mode and can be represented as a regional neural network-based prediction. The decoder module 124 may compare the regional neural network-based prediction with the regional reconstruction of the neighboring region to generate a specific one of the non-angular template costs. The specific non-angular template cost may be represented as a neural network-based template cost. The neural network-based template cost may correspond to the neural network-based intra prediction mode and be included in the non-angular template costs.

In some implementations, the neural network-based intra prediction mode may be allowed to be selected as the intra non-angular mode when the neural network-based template cost is low enough for the decoder module 124 to predict the block unit using the neural network-based intra prediction mode. In some implementations, the neural network-based intra prediction mode may be allowed to be selected as the intra non-angular mode when the neural network-based template cost is less than a specific cost value. In some implementations, the specific cost value may be calculated by multiplying a minimum template cost of the default template costs by a predefined value. In some implementations, at block 330, the default template costs may be generated in the TIMD mode, based on the neighboring region, by using the intra default candidates. Thus, each of the default template costs may corresponds to one of the intra default candidates. In some implementations, the predefined value may be greater than zero. For example, the predefined value may be equal to 1, 1.5, 2, 2.5 or 3.

Referring back to FIG. 3, at block 360, the decoder module 124 may determine, using the intra non-angular mode, a second block prediction candidate for the block unit.

With reference to FIG. 1 and FIG. 2, in some implementations, when the intra non-angular mode is the neural network-based intra prediction mode, the neural network-based block prediction of the block unit may be directly determined as the second block prediction candidate for the block unit.

In some other implementations, when the intra non-angular mode is not the neural network-based intra prediction mode, the decoder module 124 may predict the block unit by using the intra non-angular mode based on the one or more reference lines. The one or more reference lines may neighbor the block unit. In some implementations, the decoder module 124 may determine the second block prediction candidate by predicting the block unit using the intra non-angular mode.

Referring back to FIG. 3, at block 370, the decoder module 124 may determine a block prediction for the block unit by weighted blending the one or more first block prediction candidates and the second block prediction candidate.

With reference to FIG. 1 and FIG. 2, in some implementations, the decoder module 124 may determine multiple weighting parameters for the one or more first block prediction candidates and the second block prediction candidate.

In some implementations, the weighting parameters may be determined based on the default template costs of the one or more intra default modes and the non-angular template cost of the intra non-angular mode. For example, the weighting parameters may be generated based on the following equations:

$${weight}_{i} = \frac{sumCost - {costMode}_{i}}{2 \times sumCost} , sumCost = {\sum }_{i = 1}^{Nc} {costMode}_{i}$$

where the parameters weight, are multiple weighting parameters of the one or more first block prediction candidates and the second block prediction candidate, the parameters costMode; are the default template costs of the one or more intra default modes and the non-angular template cost of the intra non-angular mode, the parameter sumCost is the sum of the default template costs and the non-angular template cost, the parameter Nc is the number of the one or more intra default modes and the intra non-angular mode. Thus, Nc may be equal to Nd+1.

In some implementations, when the neural network-based intra prediction mode is selected as the intra non-angular mode, the regional non-angular prediction, generated by using the transformed intra mode, may be represented as the regional neural network-based prediction. The decoder module 124 may compare the regional neural network-based prediction with the regional reconstruction of the neighboring region to generate the neural network-based template cost. When the neural network-based intra prediction mode is selected as the intra non-angular mode, the non-angular template cost of the intra non-angular mode may be the neural network-based template cost. Thus, when the neural network-based intra prediction mode is selected as the intra non-angular mode, the decoder module 124 may determine, using the neural network-based template cost, a weighting parameter for the neural network-based intra prediction mode. In addition, the decoder module 124 may determine, using the default template costs of the one or more intra default modes and the neural network-based template cost, the weighting parameters of the one or more intra default modes and the intra non-angular mode.

In some implementations, when the neural network-based intra prediction mode is selected as the intra non-angular mode, the decoder module 124 may determine a specific template cost from multiple remaining non-angular template costs for generating the weighting parameters. The remaining non-angular template costs may be generated by excluding the neural network-based template cost from the non-angular template costs. The neural network-based template cost may be determined by using the neural network-based intra prediction mode. In some implementations, the remaining non-angular template costs may be calculated using the intra non-angular candidates other than the neural network-based intra prediction mode. For example, a specific non-angular template cost that is calculated using the DC mode may be selected as the specific template cost for generating the weighting parameters of the one or more intra default modes and the intra non-angular mode. Thus, the specific non-angular template cost that is calculated using the DC mode may be selected as the specific template cost for generating the weighting parameter of the intra non-angular mode. In some other implementations, a specific non-angular template cost that is calculated using the Planar mode may be selected as the specific template cost for generating the weighting parameter of the intra non-angular mode. In some other implementations, a specific non-angular template cost being equal to the minimum value of the remaining non-angular template costs may be selected as the specific template cost for generating the weighting parameter of the intra non-angular mode.

Referring back to FIG. 3, at block 380, the decoder module 124 may reconstruct the block unit based on the block prediction.

With reference to FIGS. 1 and 2, in some implementations, the decoder module 124 may determine multiple residual components of a residual block from the bitstream for the block unit and may add the residual components to the block prediction to reconstruct the block unit. The decoder module 124 may reconstruct all of the other block units in the image frame to reconstruct the image frame and the video.

Referring back to FIG. 3, after reconstructing the block unit (e.g., based on the block prediction), the method/process 300 may end.

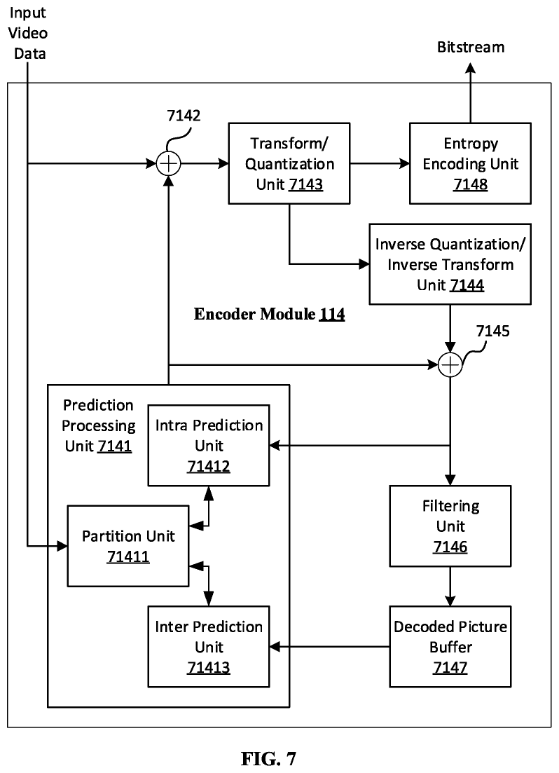

FIG. 7 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 7141), at least a first summer (e.g., a first summer 7142) and a second summer (e.g., a second summer 7145), a transform/quantization processor (e.g., a transform/quantization unit 7143), an inverse quantization/inverse transform processor (e.g., an inverse quantization/inverse transform unit 7144), a filter (e.g., a filtering unit 7146), a decoded picture buffer (e.g., a decoded picture buffer 7147), and an entropy encoder (e.g., an entropy encoding unit 7148). The prediction processing unit 7141 of the encoder module 114 may further include a partition processor (e.g., a partition unit 71411), an intra prediction processor (e.g., an intra prediction unit 71412), and an inter prediction processor (e.g., an inter prediction unit 71413). The encoder module 114 may receive the source video and encode the source video to output a bitstream.

The encoder module 114 may receive source video including multiple image frames and then divide the image frames based on a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 7141 may receive a current image block of a specific one of the image frames. The current image block may be the luminance block or one of the chrominance blocks in the specific image frame.

The partition unit 71411 may divide the current image block into multiple block units. The intra prediction unit 71412 may perform intra-predictive coding of a current block unit relative to one or more neighboring blocks in the same frame, as the current block unit, in order to provide spatial prediction. The inter prediction unit 71413 may perform inter-predictive coding of the current block unit relative to one or more blocks in one or more reference image blocks to provide temporal prediction.

The prediction processing unit 7141 may select one of the coding results generated by the intra prediction unit 71412 and the inter prediction unit 71413 based on a mode selection method, such as a cost function. The mode selection method may be a rate-distortion optimization (RDO) process.

The prediction processing unit 7141 may determine the selected coding result and provide a predicted block corresponding to the selected coding result to the first summer 7142 for generating a residual block and to the second summer 7145 for reconstructing the encoded block unit. The prediction processing unit 7141 may further provide syntax elements, such as motion vectors, intra-mode indicators, partition information, and/or other syntax information, to the entropy encoding unit 7148.

The intra prediction unit 71412 may intra-predict the current block unit. The intra prediction unit 71412 may determine an intra prediction mode directed toward a reconstructed sample neighboring the current block unit in order to encode the current block unit.

The intra prediction unit 71412 may encode the current block unit using various intra prediction modes. The intra prediction unit 71412 of the prediction processing unit 7141 may select an appropriate intra prediction mode from the selected modes. The intra prediction unit 71412 may encode the current block unit using a cross-component prediction mode to predict one of the two chroma components of the current block unit based on the luma components of the current block unit. The intra prediction unit 71412 may predict a first one of the two chroma components of the current block unit based on the second of the two chroma components of the current block unit.

The inter prediction unit 71413 may inter-predict the current block unit as an alternative to the intra prediction performed by the intra prediction unit 71412. The inter prediction unit 71413 may perform motion estimation to estimate motion of the current block unit for generating a motion vector.

The motion vector may indicate a displacement of the current block unit within the current image block relative to a reference block unit within a reference image block. The inter prediction unit 71413 may receive at least one reference image block stored in the decoded picture buffer 7147 and estimate the motion based on the received reference image blocks to generate the motion vector.

The first summer 7142 may generate the residual block by subtracting the prediction block determined by the prediction processing unit 7141 from the original current block unit. The first summer 7142 may represent the component or components that perform this subtraction.

The transform/quantization unit 7143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 7143 may perform a scan of the matrix including the quantized transform coefficients. Alternatively, the entropy encoding unit 7148 may perform the scan.

The entropy encoding unit 7148 may receive multiple syntax elements from the prediction processing unit 7141 and the transform/quantization unit 7143, including a quantization parameter, transform data, motion vectors, intra modes, partition information, and/or other syntax information. The entropy encoding unit 7148 may encode the syntax elements into the bitstream.

The entropy encoding unit 7148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 7144 may apply inverse quantization and inverse transformation to reconstruct the residual block in the pixel domain for later use as a reference block. The second summer 7145 may add the reconstructed residual block to the prediction block provided by the prediction processing unit 7141 in order to produce a reconstructed block for storage in the decoded picture buffer 7147.

The filtering unit 7146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 7145.

The decoded picture buffer 7147 may be a reference picture memory that stores the reference block to be used by the encoder module 114 to encode video, such as in intra-coding or inter-coding modes. The decoded picture buffer 7147 may include a variety of memory devices, such as DRAM (e.g., including SDRAM), MRAM, RRAM, or other types of memory devices. The decoded picture buffer 7147 may be on-chip with other components of the encoder module 114 or off-chip relative to those components.

The method/process 300 for decoding and/or encoding video data may be performed by the first electronic device 110. With reference to FIGS. 1 and 7, at block 310, the method/process 300 may start by the encoder module 114 receiving the video data. The video data received by the encoder module 114 may be a video.

At block 320, the encoder module 114 may determine a block unit of an image frame included in the video data. With reference to FIGS. 1 and 7, the encoder module 114 may determine the image frames from the video. A current frame may be one of the image frames. The encoder module 114 may further divide the current frame to determine the block unit. In some implementations, the encoder module 114 may divide the current frame to generate multiple CTUS, and may further divide a current CTU, included in the CTUs, to generate multiple divided blocks and to determine the block unit from the divided blocks.

In some other implementations, the encoder module 114 may divide the current frame to generate multiple slices or multiple tiles, and may further divide a current slice or a current tile, included in the slices or the tiles, to generate multiple CTUs. In addition, the encoder module 114 may further divide a current CTU, included in the CTUs, to generate multiple divided blocks and to determine the block unit from the divided blocks.

In some implementations, a partitioning structure of the image frame, determined by the encoder module 114, may be identical to a partitioning structure of the image frame, determined by the decoder module 124. Thus, a block location and the block size Wb×Hb of the block unit, determined by the encoder module 114, may be identical to those, determined by the decoder module 124.

At block 330, the encoder module 114 may select, using a neighboring region, one or more intra default modes from multiple intra default candidates for predicting the block unit in a template-based intra mode derivation (TIMD) mode. The neighboring region may neighbor the block unit.

With reference to FIGS. 1 and 7, the method and procedure, used by the encoder module 114 for selecting the one or more intra default modes, may be identical to those, used by the decoder module 124. Thus, the intra default candidates in the TIMD mode, determined by the encoder module 114, may be identical to those, determined by the decoder module 124. In addition, the neighboring region, the reference region, and the regional reconstruction, determined by the encoder module 114, may be identical to those, determined by the decoder module 124. Furthermore, the regional default predictions and the default template costs, determined by the encoder module 114, may be identical to those, determined by the decoder module 124. In addition, the selection scheme, used by the encoder module 114 for selecting the one or more intra default modes from the intra default candidates based on the default template costs, may be identical to that, used by the decoder module 124.

In some implementations, in the TIMD mode, the encoder module 114 may predict the neighboring region based on the reference region by using the intra default candidates to generate the regional default predictions. Thus, in the TIMD mode, the decoder module 124 may also predict the neighboring region based on the reference region by using the intra default candidates to generate the same regional default predictions.

In some implementations, the encoder module 114 may compare the regional default predictions with the regional reconstruction of the neighboring region to determine the default template costs for selecting the one or more intra default modes from the intra default candidates. Thus, the decoder module 124 may also compare the regional default predictions with the regional reconstruction of the neighboring region to determine the default template costs for selecting the same one or more intra default modes from the intra default candidates.

At block 340, the encoder module 114 may determine one or more first block prediction candidates for the block unit using the one or more intra default modes. Each of the one or more first block prediction candidates may correspond to one of the one or more intra default modes.

With reference to FIGS. 1 and 7, the method and procedure, used by the encoder module 114 for determining the one or more first block prediction candidates, may be identical to those, used by the decoder module 124. Thus, the one or more reference lines, determined by the encoder module 114 for determining the one or more first block prediction candidates, may be identical to those, determined by the decoder module 124. In addition, each of the one or more first block prediction candidates may correspond to one of the one or more intra default modes.

At block 350, the encoder module 114 may select an intra non-angular mode from multiple intra non-angular candidates that includes a neural network-based intra prediction mode.

With reference to FIGS. 1 and 7, the method and procedure, used by the encoder module 114 for selecting the intra non-angular mode, may be identical to those, used by the decoder module 124. Thus, the intra non-angular candidates, determined by the encoder module 114, may be identical to those, determined by the decoder module 124. In addition, the neighboring region, the reference region, and the regional reconstruction, determined at block 350 by the encoder module 114, may be identical to those, determined at block 350 by the decoder module 124. Furthermore, the regional non-angular predictions and the non-angular template costs, determined by the encoder module 114, may be identical to those, determined by the decoder module 124. The selection scheme, used by the encoder module 114 for selecting the intra non-angular mode from the non-angular candidates based on the non-angular template costs, may be identical to that, used by the decoder module 124.

In some implementations, before the encoder module 114 predicts the neighboring region based on the reference region in the neural network-based intra prediction mode, the encoder module 114 may predict, in advance, the block unit in the neural network-based intra prediction mode based on a neural network-based region, neighboring the block unit. In addition, the neural network-based region and the calculation functions, used in the neural network-based intra prediction mode by the encoder module 114, may be identical to those, determined by the decoder module 124.

In some implementations, in order to predict the neighboring region in the neural network-based intra prediction mode, the encoder module 114 may derive, according to multiple angular default candidates, a transformed intra mode corresponding to the neural network-based intra prediction mode of the block unit. The transformed intra mode, determined by the encoder module 114, may be identical to that, determined by the decoder module 124. Thus, the regional neural network-based prediction and the neural network-based template cost, determined by the encoder module 114, may be identical to those, determined by the decoder module 124.

In some implementations, the condition, for determining whether the neural network-based intra prediction mode is allowed to be selected as the intra non-angular mode by the encoder module 114, may also be identical to that, by the decoder module 124.

At block 360, the encoder module 114 may determine, using the intra non-angular mode, a second block prediction candidate for the block unit.

With reference to FIGS. 1 and 7, the method and procedure, used by the encoder module 114 for determining the second block prediction candidate, may be identical to those, used by the decoder module 124. In some implementations, when the intra non-angular mode is the neural network-based intra prediction mode, the neural network-based block prediction of the block unit, determined by the encoder module 114, may be identical to that, determined by the decoder module 124. Thus, the second block prediction candidate of the block unit, identical to the neural network-based block prediction and determined by the encoder module 114, may be identical to that, determined by the decoder module 124.

In some other implementations, when the intra non-angular mode is not the neural network-based intra prediction mode, the one or more reference lines, determined by the encoder module 114 for determining the second block prediction candidate, may be identical to those, determined by the decoder module 124. Thus, the second block prediction candidate, determined based on the one or more reference lines by the encoder module 114, may be identical to that, determined by the decoder module 124.

At block 370, the encoder module 114 may determine a block prediction for the block unit by weighted blending the one or more first block prediction candidates and the second block prediction candidate.

With reference to FIGS. 1 and 7, the method and procedure, used by the encoder module 114 for determining the block prediction, may be identical to those, used by the decoder module 124. In some implementations, the calculation scheme of the weighting parameters, used by the encoder module 114, may be identical to that, used by the decoder module 124. Therefore, the values of the weighting parameters, determined by the encoder module 114, may be identical to those, determined by the decoder module 124.

In some implementations, when the neural network-based intra prediction mode is selected as the intra non-angular mode, the encoder module 114 may determine, using the neural network-based template cost, the weighting parameter for the neural network-based intra prediction mode. In some other implementations, when the neural network-based intra prediction mode is selected as the intra non-angular mode, the encoder module 114 may determine, using the remaining non-angular template costs, the weighting parameter for the neural network-based intra prediction mode.

Referring back to FIG. 3, at block 380, the encoder module 114 may reconstruct the block unit based on the block prediction.

With reference to FIGS. 1 and 7, the encoder module 114 may predict the block unit based on other prediction modes to generate other block predictions. The encoder module 114 may select one of the block predictions based on a mode selection method, such as a cost function. The mode selection method may be at least one of an RDO process, a Sum of Absolute Difference (SAD) process, a Mean-removal SAD (MR-SAD) process, a Weighted SAD process, a Sum of Absolute Transformed Difference (SATD) process, a Mean Absolute Difference (MAD) process, a Mean Squared Difference (MSD) process, and a Structural SIMilarity (SSIM) process. The encoder module 114 may provide the selected coding result to the first summer 7142 for generating a residual block and to the second summer 7145 for reconstructing the encoded block unit. The reconstruction of the block unit by the encoder module 114 may be identical to the reconstruction of the block unit by the decoder module 124.

In some implementations, when one of the block predictions is selected to predict and/or reconstruct the block unit, the encoder module 114 may further provide syntax elements included in the bitstream for transmitting to the decoder module 124.

Referring back to FIG. 3, after reconstructing the block unit (e.g., based on the block prediction), the method/process 300 may end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit of an image frame that is included in the video data;
select, using a neighboring region, one or more intra default modes from a plurality of intra default candidates for predicting the block unit in a template-based intra mode derivation (TIMD) mode, the neighboring region neighboring the block unit;
determine one or more first block prediction candidates for the block unit using the one or more intra default modes, each of the one or more first block prediction candidates corresponding to one of the one or more intra default modes;
select an intra non-angular mode from a plurality of intra non-angular candidates that includes a neural network-based intra prediction mode;
determine, using the intra non-angular mode, a second block prediction candidate for the block unit;
determine a block prediction for the block unit by weighted blending the one or more first block prediction candidates and the second block prediction candidate; and
reconstruct the block unit based on the block prediction.

2. The electronic device of claim 1, wherein selecting the intra non-angular mode from the plurality of intra non-angular candidates comprises:
directly setting the neural network-based intra prediction mode as the intra non-angular mode.

3. The electronic device of claim 1, wherein selecting the intra non-angular mode from the plurality of intra non-angular candidates comprises:
determining a plurality of regional non-angular predictions for the neighboring region using the plurality of intra non-angular candidates, each of the plurality of regional non-angular predictions corresponding to one of the plurality of intra non-angular candidates;
determining a regional reconstruction of the neighboring region, the regional reconstruction being generated prior to the selection of the one or more intra default modes;
comparing each of the plurality of regional non-angular predictions with the regional reconstruction to generate a plurality of non-angular template costs, each of the plurality of non-angular template costs corresponding to one of the plurality of intra non-angular candidates; and
selecting, using the plurality of non-angular template costs, the intra non-angular mode from the plurality of intra non-angular candidates.

4. The electronic device of claim 3, wherein the one or more computer-executable instructions, when executed by the at least one processor of the electronic device, further cause the electronic device to:
derive, according to a plurality of angular default candidates, a transformed intra mode corresponding to the neural network-based intra prediction mode of the block unit, the plurality of angular default candidates being included in the plurality of intra default candidates,
wherein the regional non-angular prediction of the neural network-based intra prediction mode is determined using the transformed intra mode.

5. The electronic device of claim 3, wherein:
a neural network-based template cost that corresponds to the neural network-based intra prediction mode is included in the plurality of non-angular template costs,
a plurality of default template costs is generated, according to the neighboring region, by using the plurality of intra default candidates in the TIMD mode,
each of the plurality of default template costs corresponds to one of the plurality of intra default candidates, and
the neural network-based intra prediction mode is allowed to be selected as the intra non-angular mode when the neural network-based template cost is less than a specific cost value calculated by multiplying a minimum template cost of the plurality of default template costs by a predefined value.

6. The electronic device of claim 3, wherein the one or more computer-executable instructions, when executed by the at least one processor of the electronic device, further cause the electronic device to, in a case that the neural network-based intra prediction mode is selected as the intra non-angular mode:
determine a specific template cost from a plurality of remaining non-angular template costs generated by excluding a neural network-based template cost from the plurality of non-angular template costs, wherein the neural network-based template cost is determined by using the neural network-based intra prediction mode, and
determine, using the specific template cost, a weighting parameter for the neural network-based intra prediction mode.

7. The electronic device of claim 1, wherein the one or more computer-executable instructions, when executed by the at least one processor of the electronic device, further cause the electronic device to, in a case that the neural network-based intra prediction mode is selected as the intra non-angular mode:
derive, according to a plurality of angular default candidates, a transformed intra mode corresponding to the neural network-based intra prediction mode of the block unit, the plurality of angular default candidates being included in the plurality of intra default candidates,
determine, using the transformed intra mode, a regional neural network-based prediction for the neighboring region,
determine a regional reconstruction of the neighboring region, the regional reconstruction being generated prior to the selection of the one or more intra default modes,
compare the regional neural network-based prediction with the regional reconstruction to generate the neural network-based template cost, and
determine, using the neural network-based template cost, a weighting parameter for the neural network-based intra prediction mode.

8. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit of an image frame that is included in the video data;
select, using a neighboring region, one or more intra default modes from a plurality of intra default candidates for predicting the block unit in a template-based intra mode derivation (TIMD) mode, the neighboring region neighboring the block unit;
determine one or more first block prediction candidates for the block unit using the one or more intra default modes, each of the one or more first block prediction candidates corresponding to one of the one or more intra default modes;
select an intra non-angular mode from a plurality of intra non-angular candidates that includes a neural network-based intra prediction mode;
determine, using the intra non-angular mode, a second block prediction candidate for the block unit;
determine a block prediction for the block unit by weighted blending the one or more first block prediction candidates and the second block prediction candidate; and
reconstruct the block unit based on the block prediction.

9. The electronic device of claim 8, wherein selecting the intra non-angular mode from the plurality of intra non-angular candidates comprises:
directly setting the neural network-based intra prediction mode as the intra non-angular mode.

10. The electronic device of claim 8, wherein selecting the intra non-angular mode from the plurality of intra non-angular candidates comprises:
determining a plurality of regional non-angular predictions for the neighboring region using the plurality of intra non-angular candidates, each of the plurality of regional non-angular predictions corresponding to one of the plurality of intra non-angular candidates;
determining a regional reconstruction of the neighboring region, the regional reconstruction being generated prior to the selection of the one or more intra default modes;
comparing each of the plurality of regional non-angular predictions with the regional reconstruction to generate a plurality of non-angular template costs, each of the plurality of non-angular template costs corresponding to one of the plurality of intra non-angular candidates; and
selecting, using the plurality of non-angular template costs, the intra non-angular mode from the plurality of intra non-angular candidates.

11. The electronic device of claim 8, wherein the one or more computer-executable instructions, when executed by the at least one processor of the electronic device, further cause the electronic device to, in a case that the neural network-based intra prediction mode is selected as the intra non-angular mode:
derive, according to a plurality of angular default candidates, a transformed intra mode corresponding to the neural network-based intra prediction mode of the block unit, the plurality of angular default candidates being included in the plurality of intra default candidates,
determine, using the transformed intra mode, a regional neural network-based prediction for the neighboring region,
determine a regional reconstruction of the neighboring region, the regional reconstruction being generated prior to the selection of the one or more intra default modes,
compare the regional neural network-based prediction with the regional reconstruction to generate the neural network-based template cost, and
determine, using the neural network-based template cost, a weighting parameter for the neural network-based intra prediction mode.

12. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit of an image frame that is included in the video data;
select, using a neighboring region, one or more intra default modes from a plurality of intra default candidates for predicting the block unit in a template-based intra mode derivation (TIMD) mode, the neighboring region neighboring the block unit;
determine one or more first block prediction candidates for the block unit using the one or more intra default modes, each of the one or more first block prediction candidates corresponding to one of the one or more intra default modes;
select an intra non-angular mode from a plurality of intra non-angular candidates that includes a neural network-based intra prediction mode;
determine, using the intra non-angular mode, a second block prediction candidate for the block unit;
determine a block prediction for the block unit by weighted blending the one or more first block prediction candidates and the second block prediction candidate; and
reconstruct the block unit based on the block prediction.

13. The non-transitory machine-readable medium of claim 12, wherein selecting the intra non-angular mode from the plurality of intra non-angular candidates comprises:
directly setting the neural network-based intra prediction mode as the intra non-angular mode.

14. The non-transitory machine-readable medium of claim 12, wherein selecting the intra non-angular mode from the plurality of intra non-angular candidates comprises:
determining a plurality of regional non-angular predictions for the neighboring region using the plurality of intra non-angular candidates, each of the plurality of regional non-angular predictions corresponding to one of the plurality of intra non-angular candidates;
determining a regional reconstruction of the neighboring region, the regional reconstruction being generated prior to the selection of the one or more intra default modes;
comparing each of the plurality of regional non-angular predictions with the regional reconstruction to generate a plurality of non-angular template costs, each of the plurality of non-angular template costs corresponding to one of the plurality of intra non-angular candidates; and
selecting, using the plurality of non-angular template costs, the intra non-angular mode from the plurality of intra non-angular candidates.

15. The non-transitory machine-readable medium of claim 12, wherein the one or more computer-executable instructions, when executed by the at least one processor of the electronic device, further cause the electronic device to, in a case that the neural network-based intra prediction mode is selected as the intra non-angular mode:
derive, according to a plurality of angular default candidates, a transformed intra mode corresponding to the neural network-based intra prediction mode of the block unit, the plurality of angular default candidates being included in the plurality of intra default candidates,
determine, using the transformed intra mode, a regional neural network-based prediction for the neighboring region,
determine a regional reconstruction of the neighboring region, the regional reconstruction being generated prior to the selection of the one or more intra default modes,
compare the regional neural network-based prediction with the regional reconstruction to generate the neural network-based template cost, and
determine, using the neural network-based template cost, a weighting parameter for the neural network-based intra prediction mode.
